(19) United States
(12) Patent Application Publication
(10) Pub. No.: US 2022/0270418 A1
(43) Pub. Date: Aug. 25, 2022

(54) INFORMATION PROCESSING SYSTEM, INFORMATION PROCESSING METHOD, AND PROGRAM

(71) Applicant: TOYOTA JIDOSHA KABUSHIKI KAISHA, Aichi-ken (JP)

(72) Inventors: Takeshi MURAKAMI, Okazaki-shi (JP); Kenji YAMAGUCHI, Toyota-shi (JP)

(21) Appl. No.: 17/665,595

(22) Filed: Feb. 7, 2022

(30) Foreign Application Priority Data
Feb. 19, 2021 (JP) 2021-025555

(51) Int. Cl. G07C 5/08; B60W 30/18

(52) U.S. Cl. CPC G07C 5/0816; G07C 5/0841; B60W 30/18109; B60W 2420/42

(57) ABSTRACT

An information processing system includes a vehicle state acquisition unit configured to acquire vehicle state information, which is information on a vehicle state associated with at least one of traveling, steering, and braking of a vehicle, a damaged part information acquisition unit that acquires, in a case where image data showing a surface of the vehicle includes a damaged part of the vehicle, damaged part information, which is information on the damaged part, a damage information generation unit that generates, when the damaged part information acquisition unit acquires the damaged part information, vehicle damage information including the damaged part information and the image data which are associated with the damaged part, and an assessment information generation unit that generates assessment information including the vehicle state information and the vehicle damage information.

### CROSS-REFERENCE TO RELATED APPLICATION

This application claims priority to Japanese Patent Application No. 2021-025555 filed on Feb. 19, 2021, incorporated herein by reference in its entirety.

### BACKGROUND

### 1. Technical Field

The present disclosure relates to an information processing system, an information processing method, and a program.

### 2. Description of Related Art

Japanese Unexamined Patent Application Publication No. 2008-065474 (JP2008-065474A) discloses an information processing apparatus that assesses a vehicle based on information on, for example, a travel distance of the vehicle and provides the result to a user via the Internet.

### SUMMARY

In the system disclosed in Japanese Unexamined Patent Application Publication No. 2008-065474 (JP2008-065474A), information on damage to a surface of the vehicle may be further reflected in the assessment result.

The present disclosure provides an information processing system, an information processing method, and a program, capable of acquiring assessment information that allows the user to accurately recognize information on damage to a surface of a vehicle.

An information processing system according to a first aspect of the present disclosure includes a vehicle state acquisition unit configured to acquire vehicle state information, which is information on a vehicle state associated with at least one of traveling, steering, and braking of a vehicle, a damaged part information acquisition unit configured to, in a case where image data showing a surface of the vehicle includes a damaged part of the vehicle, acquire damaged part information, which is information on the damaged part, a damage information generation unit configured to, when the damaged part information acquisition unit acquires the damaged part information, generate vehicle damage information including the damaged part information and the image data which are associated with the damaged part, and an assessment information generation unit configured to generate assessment information including the vehicle state information and the vehicle damage information.

In the above configuration, the vehicle state acquisition unit acquires the vehicle state information, which is the information on the vehicle state. Further, in a case where the image data showing the surface of the vehicle includes the damaged part of the vehicle, the damaged part information acquisition unit can acquire the damaged part information. When the damaged part information acquisition unit acquires the damaged part information, the damage information generation unit generates the vehicle damage information including the damage part information and the image data which are associated with the damaged part based on the image data and the damaged part information. The assessment information generation unit generates the assessment information including the vehicle state information and the vehicle damage information.

The vehicle damage information included in the assessment information includes the damaged part information and image data which are associated with the damaged part of the vehicle. Therefore, the user who sees the assessment information can accurately recognize the information on the damaged part of the vehicle which is the target of the assessment information.

In the first aspect, the damaged part information acquisition unit may request, in a case where a user of the vehicle makes a request for generation of the assessment information, and past image data which is the image data acquired before latest image data includes the damaged part, the user to provide the damaged part information on the damaged part in the past image data.

In the above configuration, in a case where the user of the vehicle makes the request for generation of the assessment information, and the past image data which is the image data acquired before the latest image data includes the damaged part, the damaged part information acquisition unit requests the user to provide the damaged part information on the damaged part in the past image data. Therefore, it is highly likely that the damaged part information acquisition unit can acquire the damaged part information on the damaged part in the past image data. Consequently, it is highly likely that the vehicle damage information included in the assessment information is highly accurate.

In the first aspect, the information processing system may further include a vehicle image capturing device including a space formation unit configured to form a passing space through which the vehicle can pass, and an image capturing unit configured to acquire the image data of the vehicle located in the passing space. The damaged part information acquisition unit may request, in a case where the image data acquired by the image capturing unit includes the damaged part, the user of the vehicle to provide the damaged part information on the damaged part included in the image data acquired by the image capturing unit.

In the above configuration, the image capturing unit acquires the image data of the vehicle located in the passing space formed by the space formation unit of the vehicle image capturing device. In a case where the image data acquired by the image capturing unit includes the damaged part, the damaged part information acquisition unit requests the user of the vehicle to provide the damaged part information on the damaged part included in the image data acquired by the image capturing unit. Consequently, it is highly likely that the damaged part information acquisition unit can acquire the damaged part information in a case where the image data acquired by the image capturing unit includes the damaged part.

In the first aspect, the assessment information may include information on assessment reliability, which represents reliability of the assessment information, and the assessment information generation unit may determine the assessment reliability based on a state of the damaged part and the damaged part information provided by the user.

In the above configuration, the assessment information includes the information on the assessment reliability that the assessment information generation unit determines based on the state of the damaged part and the damaged part information provided by the user. Therefore, the person who sees the assessment information can appropriately evaluate the vehicle based on the assessment information.

In the first aspect, the assessment information may include information on user reliability, which represents reliability of the user, and the assessment information generation unit may determine the user reliability based on a state of the damaged part and the damaged part information provided by the user.

In the above configuration, the assessment information includes the information on the user reliability that the assessment information generation unit determines based on the state of the damaged part and the damaged part information provided by the user. Therefore, the person who sees the assessment information can appropriately evaluate the vehicle based on the assessment information.

An information processing method according to a second aspect of the present disclosure includes acquiring vehicle state information, which is information on a vehicle state associated with at least one of traveling, steering, and braking of a vehicle, acquiring, in a case where image data showing a surface of the vehicle includes a damaged part of the vehicle, the damaged part information, which is information on the damaged part, generating, when the damaged part information acquisition unit acquires the damaged part information, vehicle damage information including the damaged part information and the image data which are associated with the damaged part, and generating assessment information including the vehicle state information and the vehicle damage information.

A program according to a third aspect of the present disclosure causes an information processing system to execute acquiring vehicle state information, which is information on a vehicle state associated with at least one of traveling, steering, and braking of a vehicle, acquiring, in a case where image data showing a surface of the vehicle includes a damaged part of the vehicle, damaged part information, which is information on the damaged part, generating, when the damaged part information acquisition unit acquires the damaged part information, vehicle damage information including the damaged part information and the image data which are associated with the damaged part, and generating assessment information including the vehicle state information and the vehicle damage information.

As stated above, the information processing system, the information processing method, and the program, according to each aspect of the present disclosure, are advantageously capable of acquiring the assessment information that allows the user to accurately recognize the information on the damage to the surface of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a general view illustrating an information processing system according to an embodiment;

FIG. 2 is a control block diagram of a management server in the information processing system shown in FIG. 1;

FIG. 3 is a functional block diagram of the management server shown in FIG. 2;

FIG. 4 is a functional block diagram of an operation terminal in the information processing system shown in FIG. 1;

FIG. 5 is a functional block diagram of the operation terminal in the information processing system shown in FIG. 1;

FIG. 6 is a functional block diagram of a portable terminal shown in FIG. 1;

FIG. 7 is a diagram illustrating basic data generated by the management server shown in FIG. 2;

FIG. 8 is a diagram illustrating vehicle damage information included in the basic data shown in FIG. 7;

FIG. 9 is a diagram illustrating purchase assessment data generated based on the basic data shown in FIG. 7;

FIG. 10 is a diagram illustrating sales assessment data generated based on the basic data shown in FIG. 7;

FIG. 11 is a flowchart illustrating a process executed by the management server shown in FIG. 2;

FIG. 12 is a flowchart illustrating a process executed by the management server shown in FIG. 2; and

FIG. 13 is a diagram illustrating vehicle damage information of a modified example.

### DETAILED DESCRIPTION OF EMBODIMENTS

Hereinafter, embodiments of an information processing system 10 (hereinafter simply referred to as the system 10), an information processing method, and a program, according to the present disclosure, will be described referring to the drawings.

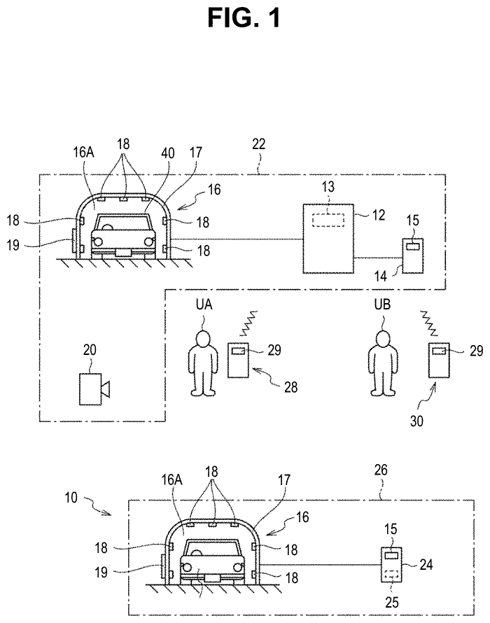

FIG. 1 shows an overall configuration of the system 10 of the embodiment. The system 10 includes a management server 12, an operation terminal 14, two vehicle image capturing devices 16, an infrared camera 20, and an operation terminal 24. The management server 12 and the operation terminal 14 are installed, for example, in a shop 22 of a second-hand car dealer who owns a plurality of vehicles (second-hand cars).

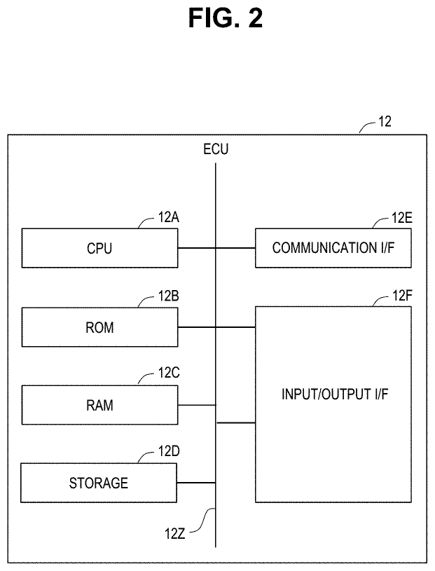

As shown in FIG. 2, the management server 12 is configured to include a CPU (central processing unit 12A), a ROM (read only memory) 12B, a RAM (random access memory) 12C, a storage 12D, a communication I/F (interface) 12E, and an input/output I/F 12F. The CPU 12A, the ROM 12B, the RAM 12C, the storage 12D, the communication I/F 12E, and the input/output I/F 12F are connected to each other so as to establish communication therebetween via a bus 12Z. The management server 12 can acquire information on a date and time from a timer (not shown).

The CPU 12A is a central processing unit that executes various programs and controls each unit. That is, the CPU 12A reads the program from the ROM 12B or the storage 12D and executes the program using the RAM 12C as a work area. The CPU 12A controls the components stated above and performs various arithmetic processes (information processing) according to programs recorded in the ROM 12B or the storage 12D.

The ROM 12B stores various programs and various data. The RAM 12C temporarily stores a program or data as a work area. The storage 12D is configured by a storage device such as a hard disk drive (HDD) or a solid state drive (SSD), which stores various programs and various data. The communication I/F 12E is an interface through which the management server 12 communicates with other devices. The input/output I/F 12F is an interface for communicating with various devices. For example, a wireless communication device 13 provided in the management server 12 is connected to the input/output I/F 12F. The wireless communication device 13 can establish wireless communication, via, for example, the Internet, between the operation terminal 24 and the portable terminals 28 and 30.

A LAN (local area network) is connected to the communication I/F 12E of the management server 12 and a communication I/F of the operation terminal 14.

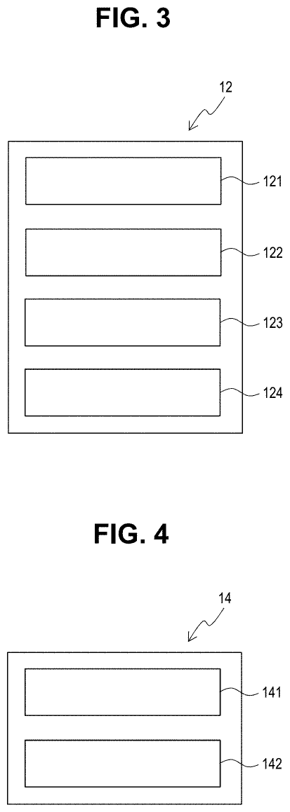

FIG. 3 shows one example of a functional configuration of the management server 12 in a block diagram. The management server 12 has a transceiver unit 121 (vehicle state acquisition unit and damaged part information acquisition unit), a wireless control unit 122, an assessment information generation unit 123, and a damage information generation unit 124 as the functional configuration. The transceiver unit 121, the wireless control unit 122, the assessment information generation unit 123 and the damage information generation unit 124 are implemented by the CPU 12A reading and executing the program stored in the ROM 12B.

The transceiver unit 121 transmits/receives the information to/from the operation terminal 14 (transceiver unit 141) via the LAN. For example, the transceiver unit 121 acquires damaged part information from the operation terminal 14 as described later. Further, the transceiver unit 121 acquires infrared image data from the infrared camera 20 as described later.

The wireless control unit 122 controls the wireless communication device 13. That is, the wireless control unit 122 controls the wireless communication device 13 such that the wireless communication device 13 establishes wireless communication between the operation terminal 24 and the portable terminals 28 and 30.

The assessment information generation unit 123 generates basic data 45, purchase assessment data 52, and sales assessment data 54, as described later.

The damage information generation unit 124 generates vehicle damage information as described later.

The operation terminal 14 is configured to include a CPU, a ROM, a RAM, a storage, a communication I/F, and an input/output I/F. The CPU, the ROM, the RAM, the storage, the communication I/F, and the input/output I/F of the operation terminal 14 are connected to each other so as to establish communication therebetween via a bus. The operation terminal 14 can acquire information on a date and time from a timer (not shown). The operation terminal 14 is provided with a display unit 15 having a touchscreen. The display unit 15 is connected to the input/output I/F of the operation terminal 14.

FIG. 4 shows one example of a functional configuration of the operation terminal 14 in a block diagram. The operation terminal 14 has a transceiver unit 141 and a display control unit 142 as the functional configuration. The transceiver unit 141 and the display control unit 142 are implemented by executing the program stored in the ROM by the CPU.

The transceiver unit 141 transmits/receives data to/from the transceiver unit 121 of the management server 12.

The display control unit 142 controls the display unit 15. That is, the display control unit 142 causes the display unit 15 to display, for example, information received by the transceiver unit 141 from the transceiver unit 121, as well as information input via the touchscreen. The information input by the touchscreen of the display unit 15 can be transmitted by the transceiver unit 141 to the transceiver unit 121.

A vehicle image capturing device 16 is installed in the shop 22. The vehicle image capturing device 16 includes a main body unit 17 (a space formation unit), a camera 18 (image capturing unit), and an operation panel 19. A front of the main body unit 17 is U-shaped, and a passing space 16A is formed between a floor surface of the shop 22 and the main body unit 17. A vehicle 40 can pass through the vehicle image capturing device 16 (main body unit 17) in a longitudinal direction (direction orthogonal to a paper surface). This vehicle 40 (second-hand car) is property of a member UA of the system 10. A plurality of cameras 18 are provided on an inner peripheral surface of the main body unit 17. Further, the operation panel 19 capable of controlling the vehicle image capturing device 16 (camera 18) is provided on an outer surface of the main body unit 17. The operation panel 19 transmits/receives information to/from the transceiver unit 121 of the management server 12 via the LAN.

The infrared camera 20 can record captured infrared image data in a portable memory (for example, an SD card) (not shown). The infrared image data recorded in the memory can be stored in the storage 12D via the transceiver unit 121 of the management server 12. When the infrared camera 20 has a wireless function, the infrared camera 20 may wirelessly transmit the infrared image data to the management server 12 and store the infrared image data in the storage 12D.

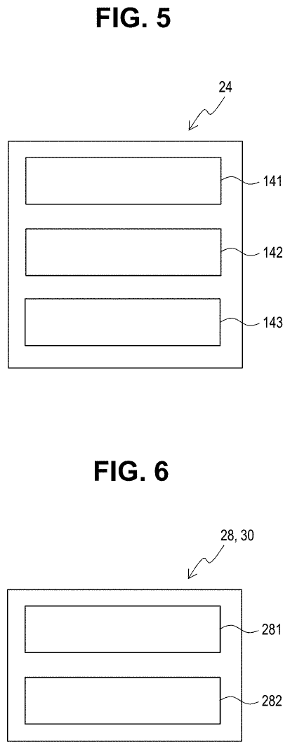

The vehicle image capturing device 16 is also installed in a shop 26 located away from the shop 22. Further, the operation terminal 24 is installed in the shop 26. The operation terminal 24 has the display unit 15. As shown in FIG. 5, the operation terminal 24 has the transceiver unit 141, the display control unit 142, and a wireless control unit 143 as a functional configuration. The operation panel 19 transmits/receives information to/from the transceiver unit 141 of the operation terminal 24 via the LAN. Further, a wireless communication device 25 of the operation terminal 24 controlled by the wireless control unit 143 establishes wireless communication with the wireless communication device 13 of the management server 12.

When the operation panel 19 is operated while a vehicle is arranged in the passing space 16A formed by the vehicle image capturing device 16 of at least one of the shops 22 and 26, the plurality of cameras 18 capture a surface of the vehicle. That is, the plurality of cameras 18 generates image data of, for example, a front surface, a side surface, a rear surface, and an upper surface of the vehicle. When the cameras 18 have completely captured the vehicle, the vehicle moves from the passing space 16A to the outside of the vehicle image capturing device 16. The image data acquired by each camera 18 of the vehicle image capturing device 16 in the shop 22 is transmitted to the transceiver unit 121 of the management server 12 via the LAN and stored in the storage 12D. Further, the image data acquired by each camera 18 of the vehicle image capturing device 16 in the shop 26 is transmitted to the operation terminal 24, and further transmitted from the wireless communication device 25 of the operation terminal 24 to the wireless communication device 13 of the management server 12. The image data received by the wireless communication device 13 is stored in the storage 12D. Furthermore, a vehicle ID is assigned to all vehicles owned by all members (users) registered with the second-hand car dealer. Furthermore, each member is assigned a member ID. The image data transmitted from each vehicle image capturing device 16 to the management server 12 includes information representing the date and time when the image has been captured, the vehicle ID, and the member ID.

The portable terminal 28 shown in FIG. 1 is owned by a member UA, and the portable terminal 30 is owned by a member UB. The member UA wants to sell the vehicle 40. A vehicle ID of the vehicle 40 is “40”. A member ID of the member UA is “400”. The member UB wants to purchase the vehicle 40. A member ID of the member UB is “500”. The portable terminals 28 and 30 are respectively, for example, a smartphone or a tablet computer. The portable terminals 28 and 30 respectively include a display unit 29 having a touchscreen. The portable terminals 28 and 30 are respectively configured to include a CPU, a ROM, a RAM, a storage, a communication I/F, and an input/output I/F. The CPU, the ROM, the RAM, the storage, the communication I/F, and the input/output I/F are connected to each other so as to establish communication therebetween via a bus. The portable terminals 28 and 30 can acquire information on a date and time from a timer (not shown). The portable terminals 28 and 30 can establish wireless communication with the wireless communication device 13. Further, an assessment application, which is software created by the second-hand car dealer, is installed on each of the portable terminals 28 and 30.

FIG. 6 shows one example of a functional configuration of the portable terminals 28 and 30 in a block diagram. The portable terminals 28 and 30 respectively have a wireless control unit 281 and a display control unit 282 as a functional configuration. The display control unit 282 has the same function as the display control unit 142 of the operation terminal 14. Further, the portable terminals 28 and 30, each of which is controlled by the wireless control unit 281, establish wireless communication with the wireless communication device 13 of the management server 12 and the wireless communication device 25 of the operation terminal 24. The wireless control unit 281 and the display control unit 282 are implemented by executing the program stored in the ROM by the CPU.

The vehicle 40 is provided with a device for acquiring the vehicle state information, which is the information on the vehicle state. This vehicle state includes a vehicle state associated with at least one of traveling, steering, and braking of the vehicle 40. For example, the vehicle state includes cumulative travel distance of the vehicle 40, engine state (for example, cooling water temperature or rotation speed), brake pressure, battery state, steering amount (steering angle or steering torque), accelerator opening, and brake pedal force applied to a brake pedal. A signal acquired by each sensor (for example, a water temperature sensor, a steering angle sensor, a pedal force sensor, and an accelerator opening sensor) that acquires vehicle state information about the vehicle state is stored in a recording device of the vehicle 40 via a CAN (controller area network) provided in the vehicle 40. Various pieces of vehicle state information stored in the recording device can be recorded in a portable memory (for example, an SD card) (not shown). The vehicle state information recorded in the memory can be stored in the storage 12D of the management server 12. When the vehicle 40 has a wireless function, the vehicle 40 may wirelessly transmit the vehicle state information to the management server 12 and record the vehicle state information in the storage 12D.

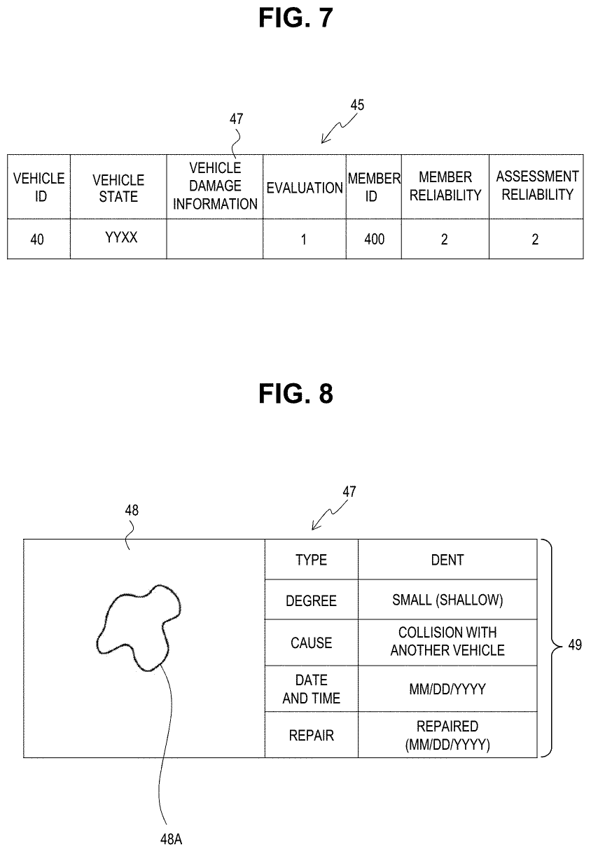

Further, the vehicle state information includes information that cannot be acquired from the CAN in addition to the information stated above. The information that cannot be acquired from the CAN includes, for example, manufacturer name, model name, model year, and engine displacement of the vehicle. The information that cannot be acquired form the CAN, the vehicle ID, and the member ID can be input using at least one of the display unit 15 (touchscreen) of the operation terminal 14 and the display unit 29 (touchscreen) of the portable terminal 28. When the vehicle state information acquired from the CAN and the information that cannot be acquired from the CAN are received by the management server 12 from the operation terminal 14 (portable terminal 28), these pieces of information are stored in the storage 12D. The assessment information generation unit 123 generates the basic data 45 (assessment information) shown in FIG. 7, based on the information stored in the storage 12D.

Operation and Effect

The operation and effect of the present embodiment will be described hereinbelow.

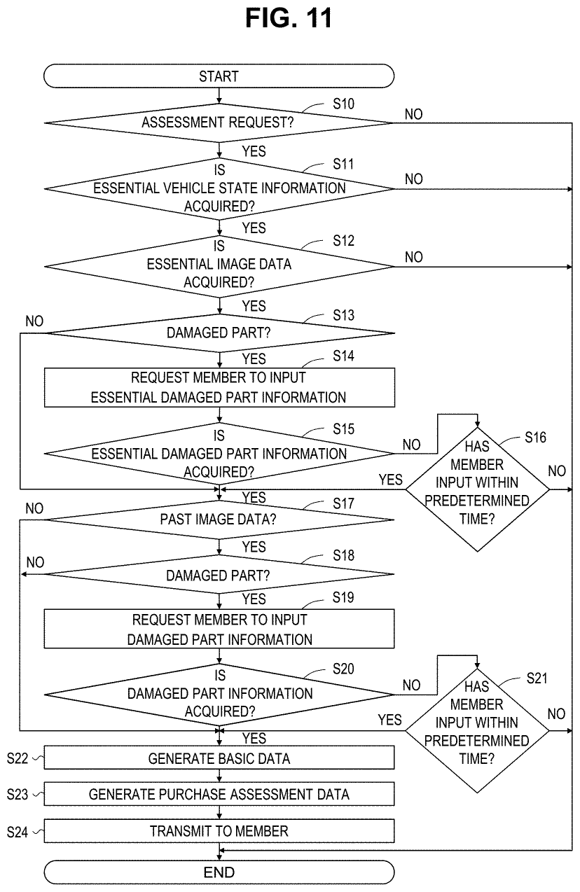

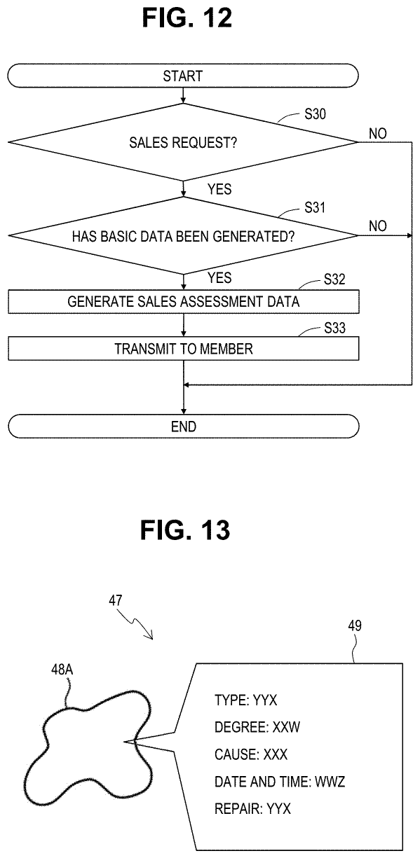

A flow of process executed by the management server 12 in a case where the vehicle 40 of the member UA is assessed will be described referring to the flowcharts shown in FIGS. 11 and 12.

The management server 12 repeatedly executes the process of the flowchart shown in FIG. 11 every time a predetermined time elapses.

First, the transceiver unit 121 of the management server 12 makes a determination on whether the transceiver unit 141 of the operation terminal 14, or alternatively, whether the portable terminal 28 in which the assessment application is running has received an “assessment request” in step S10. The assessment request includes the vehicle ID (40) and the member ID (400).

When a determination of “YES” is made in step S10, the management server 12 proceeds to step S11, and the assessment information generation unit 123 makes a determination on whether the storage 12D of the management server 12 contains essential vehicle state information. The essential vehicle state information is the vehicle condition information acquired after a predetermined date and time before the current date and time. For example, it is assumed that the predetermined date and time is one month before the current date. In this case, the vehicle state information acquired one hour before the current time is the essential vehicle condition information. Meanwhile, the vehicle state information acquired six months before the current time is not the essential vehicle condition information.

When a determination of “YES” is made in step S11, the management server 12 proceeds to step S12, and the damage information generation unit 124 makes a determination on whether the storage 12D of the management server 12 contains essential image data. The essential image data is the latest image data from among the image data showing the surface of the vehicle 40. For example, the vehicle image capturing device 16 of the shop 22 acquires the latest image data of the vehicle 40 one year after a date when the vehicle image capturing device 16 of the shop 26 has acquired the image data of the vehicle 40, and thereafter, no image data of the vehicle 40 has been acquired yet. In such a case, the image data acquired by the vehicle image capturing device 16 of the shop 22 is the essential image data. Meanwhile, the image data acquired by the vehicle image capturing device 16 of the shop 26 is not the essential image data. Hereinafter, the image data acquired by the vehicle image capturing device 16 of the shop 26 before the latest image data will be referred to as “past image data”. The “surface of the vehicle 40” is a concept that includes not only an outer surface of the vehicle 40 (for example, the front surface, the rear surface, the side surface, and the upper surface of the vehicle 40) but also a surface of a vehicle compartment (for example, a surface of a seat).

When a determination of “YES” is made in step S12, the management server 12 proceeds to step S13, and the damage information generation unit 124 makes a determination on whether the essential image data includes a damaged part. The damage information generation unit 124 makes a determination on whether the essential image data includes the damaged part by means of, for example, pattern matching.

When a determination of “YES” is made in step S13, the management server 12 proceeds to step S14 and transmits a message requesting input of essential damaged part information to the operation terminal 14 or the portable terminal 28 to which the transceiver unit 121 has transmitted the assessment request. This message is displayed on the display unit 15 of the operation terminal 14 or the display unit 29 of the portable terminal 28.

The management server 12 that has completed the process of step S14 proceeds to step S15, and the damage information generation unit 124 makes a determination on whether the essential damaged part information is stored in the storage 12D. The damaged part information is information on the damaged part included in the image data of the vehicle 40. Further, the essential damaged part information is the damaged part information of the damaged part included in the essential image data. The damaged part information includes, for example, type of the damage (e.g. dent, fading, or scratch), degree of the damage (in a case of the dent, the depth), cause of the damage that has occurred (e.g. collision with another vehicle), date and time when the damage occurred, and repair information (whether repair is required or not, or details of repair). The damaged part information is input by the member UA using the display unit 15 (touchscreen) of the operation terminal 14 or 24, or alternatively, the display unit 29 (touchscreen) of the portable terminal 28, in association with the vehicle ID and the member ID.

When a determination of “NO” is made in step S15, the management server 12 proceeds to step S16, and the damage information generation unit 124 makes a determination on whether the member UA inputs the essential damaged part information to the operation terminal 14 or the portable terminal 28 within a predetermined time from the time when the message was transmitted, and the transceiver unit 121 or the wireless communication device 13 receives the essential damaged part information. The damaged part information (essential damaged part information) received by the transceiver unit 121 or the wireless communication device 13 is stored in the storage 12D. When a determination of “NO” is made in step S16, the management server 12 temporarily ends the process of the flowchart shown in FIG. 11. On the other hand, when a determination of “YES” is made in step S15 or step S16, and when a determination of “NO” is made in step S13, the management server 12 proceeds to step S17.

The damage information generation unit 124 of the management server 12 that has proceeded to step S17 makes a determination on whether the past image data is stored in the storage 12D. When a determination of “YES” is made in step S17, the management server 12 proceeds to step S18, and the damage information generation unit 124 makes a determination on whether the past image data includes a damaged part.

When a determination of “YES” is made in step S18, the management server 12 proceeds to step S19 and transmits a message requesting input of the damaged part information of the damaged part, included in the past image data, to the operation terminal 14 or the portable terminal 28 to which the transceiver unit 121 has transmitted the assessment request. The management server 12 that has completed the process of step S19 proceeds to step S20, and makes a determination on whether the damaged part information of the damaged part included in the past image data is stored in the storage 12D.

When a determination of “NO” is made in step S20, the management server 12 proceeds to step S21, and the damage information generation unit 124 makes a determination on whether the member UA inputs the damaged part information to the operation terminal 14 or the portable terminal 28 within a predetermined time from the time when the message is transmitted, and the transceiver unit 121 or the wireless communication device 13 receives the damaged part information. When a determination of “NO” is made in step S21, the management server 12 temporarily ends the process of the flowchart shown in FIG. 11.

When a determination of “YES” is made in step S20 or step S21, or alternatively, when a determination of “NO” is made in step S18, the management server 12 proceeds to step S22. The assessment information generation unit 123 of the management server 12 that has proceeded to step S22 generates the basic data 45 using the essential vehicle state information, the essential image data (as well as the past image data), and the damaged part information, which are stored in the storage 12D. The basic data 45 includes the vehicle ID and the member ID.

Vehicle damage information 47 included in the basic data 45 is generated by the damage information generation unit 124. As shown in FIG. 8, the vehicle damage information 47 includes image data 48 and damaged part information 49. When a determination of “YES” is made in at least one of steps S13 and S18, the image data 48 of the vehicle damage information 47 includes a damaged part 48A. Data representing the damaged part 48A and data representing the damaged part information 49 are associated with (linked to) each other. The damaged part information 49 includes information on the damaged part 48A, for example, type (e.g. dent), degree (e.g. small), cause of the damage (e.g. collision with another vehicle), date and time when the damaged occurred, and repair information (whether repair is required or not, or details of repair). When a determination of “NO” is made in at least one of steps S17 and S18, as well as in step S13, the basic data 45 does not include the damaged part information.

The assessment information generation unit 123 assesses the vehicle 40 based on the vehicle state information and the vehicle damage information 47. For example, the assessment information generation unit 123 can perform the assessment on a five-point rating scale. In this case, for example, the smaller the evaluation score number (1 to 5) is, the higher the evaluation score is, and the larger the number is, the lower the evaluation score is. For example, when the basic data 45 does not include the damaged part information (when the vehicle has no damaged part), the vehicle 40 is given a higher evaluation score. Further, when the basic data 45 includes the damaged part information, the smaller the degree of damage, the higher the evaluation score given to the vehicle 40. For example, the shorter the cumulative travel distance included in the vehicle state information, the higher the evaluation score given to the vehicle 40. For example, the longer the time until the next vehicle inspection time included in the vehicle state information, the higher the evaluation score given to the vehicle 40.

Moreover the assessment information generation unit 123 determines member reliability (user reliability), which represents reliability of the member based on the vehicle damage information 47, as well as the infrared image data acquired by the infrared camera 20 and stored in the storage 12D. In a case where the infrared image data acquired by the infrared camera 20 includes the damaged part 48A, it is possible to make a determination on degree of accuracy of the repair information included in the damaged part information 49 acquired by comparing the infrared image data with the image data 48 (damaged part 48A). The more accurate the repair information, the higher the member reliability. For example, the smaller the number (1 to 5) representing the member reliability, the higher the reliability, and the larger the number, the lower the reliability. This determination can be made by the assessment information generation unit 123. This determination can be made by an inspector who visually observes the infrared image data and the image data 48 (damaged part 48A). In such a case, the inspector inputs the number representing the member reliability on the display unit 15 (touchscreen) of the operation terminal 14, and the input number is recorded in the basic data 45.

Further, the assessment information generation unit 123 makes a determination on assessment reliability, which represents reliability of the basic data 45 based on the accuracy of the repair information included in the damaged part information 49. The more accurate the repair information, the higher the assessment reliability. For example, the smaller the number (1 to 5) representing the assessment reliability, the higher the reliability, and the larger the number, the lower the reliability.

Additionally, there may be a case where the vehicle has a damaged part (for example, scratches on the wheel) that is considered to be difficult for the member to notice, and such a damaged part is not reflected in the vehicle damage information 47. In this case, it is not necessary to reflect the difference between the damaged part (image data and damaged part information) and the infrared image data in the member reliability and the assessment reliability. This difference may be slightly reflected in the member reliability and the assessment reliability.

In step S22, the management server 12 stores the generated basic data 45 in the storage 12D.

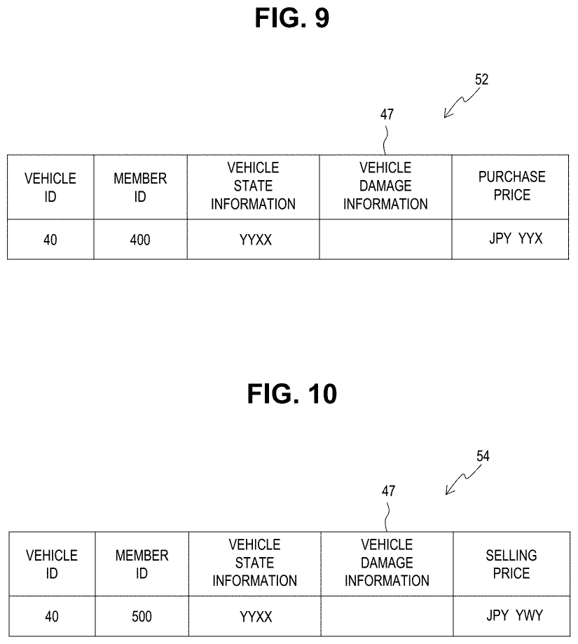

The management server 12 that has completed the process of step S22 proceeds to step S23, and the assessment information generation unit 123 generates purchase assessment data 52 (assessment information), shown in FIG. 9, based on the basic data 45 stored in the storage 12D. The purchase assessment data 52 includes the vehicle ID, the member ID, the vehicle state information, the vehicle damage information 47, and a purchase price. The assessment information generation unit 123 makes a determination on the purchase price considering the details of the basic data 45 (vehicle state information, the vehicle damage information 47, the member reliability, and the assessment reliability), as well as a market price of a vehicle having the same model, model year, and displacement as the vehicle 40. The management server 12 stores the generated purchase assessment data 52 in the storage 12D.

The management server 12 that has completed the process of step S23 proceeds to step S24, and transmits the purchase assessment data 52 to the operation terminal 14 or the portable terminal 28 to which the transceiver unit 121 has transmitted the assessment request.

When the management server 12 ends the process of step S24, or makes a determination of “NO” in steps S10, S11, S12, S16 and S21, the management server 12 temporarily ends the process of the flowchart shown in FIG. 11.

The management server 12 repeatedly executes the process of the flowchart shown in FIG. 12 every time a predetermined time elapses.

First, the transceiver unit 121 of the management server 12 makes a determination on whether the transceiver unit 141 of the operation terminal 14, or alternatively, the portable terminal 30 in which the assessment application is running has received a “sales request” in step S30. The sales request includes the member ID (500) of the member UB who wants to purchase the vehicle and the vehicle ID (40) of the vehicle that they want to purchase.

When a determination of “YES” is made in step S30, the management server 12 proceeds to step S31, and a determination is made on whether the basic data 45 of the vehicle 40 is stored in the storage 12D.

When a determination of “YES” is made in step S31, the management server 12 proceeds to step S32, and the assessment information generation unit 123 generates sales assessment data 54 (assessment information), shown in FIG. 10, based on the basic data 45 stored in the storage 12D. The sales assessment data 54 includes the vehicle ID, the member ID, the vehicle state information, the vehicle damage information 47, and a selling price. The assessment information generation unit 123 makes a determination on the selling price in consideration of the purchase price of the purchase assessment data 52. The management server 12 stores the generated sales assessment data 54 in the storage 12D.

The management server 12 that has completed the process of step S32 proceeds to step S33, and transmits the sales assessment data 54 to the operation terminal 14 or the portable terminal 30 to which the transceiver unit 121 has transmitted the sales request.

When the management server 12 ends the process of step S33, or makes a determination of “NO” in steps S30 and S31, the management server 12 temporarily ends the process of the flowchart shown in FIG. 12.

As described above, in the system 10 and the information processing method of the present embodiment, the vehicle damage information 47 included in the sales assessment data 54 includes the damaged part information 49 and the image data 48, which are associated with the damaged part 48A of the vehicle 40. Therefore, the member UB who sees the sales assessment data 54 displayed on the display unit 15 of the operation terminal 14 or the display unit 29 of the portable terminal 30 can accurately recognize the information on the damaged part 48A of the vehicle 40. Consequently, the member UB can decide whether to purchase the vehicle 40 by referring to the information on the damaged part 48A.

In the system 10 and the information processing method of the present embodiment, in a case where the member UA makes the assessment request, and the past image data, which is the image data acquired before the latest image data 48, includes the damaged part, the transceiver unit 121 requests the member UA to provide the damaged part information associated with the damaged part in the past image data. Therefore, it is highly likely that the management server 12 can acquire the damaged part information on the damaged part in the past image data. Accordingly, it is highly likely that the vehicle damage information 47, included in the basic data 45, the purchase assessment data 52, and the sales assessment data 54, is more accurate. The member UB who sees the sales assessment data 54 can decide whether to purchase the vehicle 40 by referring to the highly accurate information on the damaged part 48A.

Further, in the system 10 and the information processing method of the present embodiment, the plurality of cameras 18 acquires the image data of the vehicle located in the passing space 16A formed by the main body unit 17 of the vehicle image capturing device 16. In a case where the image data 48 acquired by the cameras 18 includes the damaged part 48A, the transceiver unit 121 requests the member UA to provide the damaged part information 49 associated with the damaged part 48A included in the image data 48 acquired by the cameras 18. Consequently, it is highly likely that the management server 12 can acquire the damaged part information 49 in a case where the damaged part 48A is included in the image data 48.

Further, in the system 10 and the information processing method of the present embodiment, the basic data 45 includes the information on the assessment reliability and the member reliability, which are determined by the assessment information generation unit 123 based on the state of the damaged part 48A (infrared image data) and the damaged part information 49 provided by the member UA. Therefore, a person who sees the basic data 45 (for example, an employee of the second-hand car dealer) can appropriately evaluate the vehicle based on the basic data 45.

The system 10, the information processing method, and the program, according to the first and second embodiments, have been described above, however the design of the system 10, the information processing method, and the program can be appropriately modified to an extent not deviating from the gist of the present disclosure.

Steps S20 and 21 may be omitted from the flowchart shown in FIG. 11. In this case, it is likely that the damaged part information of the damaged part in the past image data is not transmitted to the management server 12. The management server 12 generates the basic data 45 based on the latest image data and the damaged part information thereof.

The system 10 may not include at least one of the operation terminal 14 and the vehicle image capturing device 16. In this case, for example, the surface of the vehicle is captured by a camera provided on a portable terminal owned by the member who wants to sell the vehicle, and the acquired image data and damaged part information are wirelessly transmitted from the portable terminal to the management server 12.

The system 10 may not include the infrared camera 20.

The system 10 may not include the vehicle image capturing device 16 and the operation terminal 24, installed in the shop 26.

For example, the damaged part 48A of the vehicle damage information 47 in the purchase assessment data 52 or the sales assessment data 54, displayed on the display unit 15 of the operation terminal 14 or the display unit 29 of the portable terminal 28 or 30, may be selectable by a selection device (a cursor displayed on the display unit, or a finger of a hand touching on a touchscreen). Further, as shown in FIG. 13, when the damaged part 48A is selected by the selection device, the data representing the damaged part 48A and the data representing the damaged part information 49 are associated with each other, such that the damaged part information 49 of the damaged part 48A is displayed in the form of a balloon.

The assessment reliability may be included in at least one of the purchase assessment data 52 and the sales assessment data 54.

The member reliability may be included in at least one of the purchase assessment data 52 and the sales assessment data 54.

What is claimed is:

1. An information processing system comprising:
a vehicle state acquisition unit configured to acquire vehicle state information, which is information on a vehicle state associated with at least one of traveling, steering, and braking of a vehicle;
a damaged part information acquisition unit configured to, in a case where image data showing a surface of the vehicle includes a damaged part of the vehicle, acquire damaged part information, which is information on the damaged part;
a damage information generation unit configured to, when the damaged part information acquisition unit acquires the damaged part information, generate vehicle damage information including the damaged part information and the image data which are associated with the damaged part; and
an assessment information generation unit configured to generate assessment information including the vehicle state information and the vehicle damage information.

2. The information processing system according to claim 1, wherein the damaged part information acquisition unit is configured to, in a case where a user of the vehicle makes a request for generation of the assessment information, and past image data which is the image data acquired before latest image data includes the damaged part, request the user to provide the damaged part information on the damaged part in the past image data.

3. The information processing system according to claim 1, further comprising:
a vehicle image capturing device including a space formation unit configured to form a passing space through which the vehicle is allowed to pass and an image capturing unit configured to acquire the image data of the vehicle located in the passing space,
wherein the damaged part information acquisition unit is configured to, in a case where the image data acquired by the image capturing unit includes the damaged part, request a user of the vehicle to provide the damaged part information on the damaged part included in the image data acquired by the image capturing unit.

4. The information processing system according to claim 2, wherein:
the assessment information includes information on assessment reliability, which represents reliability of the assessment information; and
the assessment information generation unit is configured to determine the assessment reliability based on a state of the damaged part and the damaged part information provided by the user.

5. The information processing system according to claim 2, wherein:
the assessment information includes information on user reliability, which represents reliability of the user; and
the assessment information generation unit is configured to determine the user reliability based on a state of the damaged part and the damaged part information provided by the user.

6. An information processing method comprising:
acquiring vehicle state information, which is information on a vehicle state associated with at least one of traveling, steering, and braking of a vehicle;
acquiring, in a case where image data showing a surface of the vehicle includes a damaged part of the vehicle, damaged part information, which is information on the damaged part;
generating, when the damaged part information acquisition unit acquires the damaged part information, vehicle damage information including the damaged part information and the image data which are associated with the damaged part; and
generating assessment information including the vehicle state information and the vehicle damage information.

7. A program causing an information processing system to execute:
acquiring vehicle state information, which is information on a vehicle state associated with at least one of traveling, steering, and braking of a vehicle;
acquiring, in a case where image data showing a surface of the vehicle includes a damaged part of the vehicle, damaged part information, which is information on the damaged part;
generating, when the damaged part information acquisition unit acquires the damaged part information, vehicle damage information including the damaged part information and the image data which are associated with the damaged part; and
generating assessment information including the vehicle state information and the vehicle damage information.
